(19) United States
(12) Patent Application Publication
(10) Pub. No.: US 2026/0176154 A1
(43) Pub. Date: Jun. 25, 2026

(54) Positive Electrode Active Material, Method for Producing the Same, and Positive Electrode and Lithium Secondary Battery Including the Same

(71) Applicant: LG Energy Solution, Ltd., Seoul (KR)

(72) Inventors: Joong Ho Bae, Daejeon (KR); Chi Ho Jo, Daejeon (KR); Jong Woo Kim, Daejeon (KR); Seung Su Yoo, Daejeon (KR); Hee Ju Ahn, Daejeon (KR); Ha Neul Kim, Daejeon (KR)

(73) Assignee: LG Energy Solution, Ltd., Seoul (KR)

(21) Appl. No.: 19/426,301

(22) Filed: Dec. 19, 2025

(30) Foreign Application Priority Data
Dec. 23, 2024 (KR) 10-2024-0194811

(51) Int. Cl. C01G 53/04; H01M 10/0525

(52) U.S. Cl. CPC C01G 53/04; H01M 10/0525; C01P 2002/74; C01P 2006/40

(57) ABSTRACT

A positive electrode active material of the present disclosure includes lithium nickel-based oxide particles in which a molar ratio of nickel among total transition metals ranges from about 50 mol % to 70 mol %, and a coating layer formed on a surface of the lithium nickel-based oxide particles and including cobalt. The lithium nickel-based oxide particles are in a single particle form having one nodule, or a quasi-single-particle form that is a composite of 30 or fewer nodules, and the full width at half maximum (FWHM) of the (104) peak measured by X-ray diffraction (XRD) analysis of the positive-electrode active material ranges from 0.078 to 0.082.

### CROSS-REFERENCE TO RELATED APPLICATIONS

This application is based on and claims priority from Korean Patent Application No. 10-2024-0194811 filed on Dec. 23, 2024, with the Korean Intellectual Property Office, the disclosure of which is incorporated herein in its entirety by reference.

### TECHNICAL FIELD

The present disclosure relates to a positive electrode active material, a method of producing the same, and a positive electrode and a lithium secondary battery including the same.

### BACKGROUND

Lithium secondary batteries are used in various fields, not only in small products such as digital cameras, power-digital video displays (P-DVDs), MP3 players (MP3Ps), mobile phones, personal digital assistants (PDAs), portable game devices, power tools, and E-bikes, but also in large products requiring high output such as in electric vehicles and hybrid vehicles, as well as power storage systems configured to store surplus generated power or renewable energy and in backup power storage systems.

Such lithium secondary batteries are generally manufactured by injecting or impregnating a non-aqueous electrolyte into an electrode assembly including a positive electrode, a negative electrode, and a separator, and the positive electrode and the negative electrode include active materials capable of intercalating and deintercalating lithium ions.

### SUMMARY

The present disclosure provides a positive electrode active material, which is capable of improving low-temperature resistance characteristics and electrochemical performance of a positive electrode even though the manganese content is relatively high, and a method of producing the same.

In addition, the disclosure provides a positive electrode and a lithium secondary battery including the above-described positive electrode active material.

[1] The present disclosure relates to a positive electrode active material including: lithium nickel-based oxide particles in which a molar ratio of nickel among total transition metals ranges from about 50 mol % to 70 mol %; and a coating layer formed on a surface of the lithium nickel-based oxide particles and including cobalt. The lithium nickel-based oxide particles are in a single particle form having one nodule or in a quasi-single particle form that is a composite of 30 or fewer nodules. The positive electrode active material satisfies Equation 1:

$$0.078 \leq F \leq 0.082 \qquad [ Equation 1 ]$$

In Equation 1, F is a full width at half maximum (FWHM) of a (104) peak measured by X-ray diffraction (XRD) analysis of the positive electrode active material.

[2] The present disclosure provides the positive electrode active material according to [1], in which a molar ratio of nickel in the lithium nickel-based oxide particles ranges from about 60 mol % to 70 mol % based on total transition metals.

[3] The present disclosure provides the positive electrode active material according to [1] and/or [2], in which the lithium nickel-based oxide particles are represented by Formula 1:

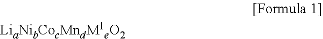

In Formula 1, M¹ is at least one selected from Al, Ba, Zr, Ti, Ta, Nb, Y, W, Sr, B, Mg, Mo, Ce, F, and P, and the symbols “a,” “b,” “c,” “d,” and “e” satisfy 0.9≤a≤1.1, 0.5≤b≤0.7, 0<c≤0.5, 0<d≤0.4, and 0≤e≤0.2.

[4] The present disclosure provides the positive electrode active material according to at least one of [1] to [3], in which a cobalt content included in the coating layer ranges from about 1 mol % to 5 mol % based on 100 mol of the lithium nickel-based oxide.

[5] The present disclosure provides a method of preparing a positive electrode active material, the method including: mixing a transition metal precursor including nickel, cobalt, and manganese with a first lithium raw material, followed by calcination, to prepare a lithium nickel-based oxide; and mixing the prepared lithium nickel-based oxide with a cobalt raw material and a second lithium raw material, followed by heat treatment to prepare a positive electrode active material including a coating layer on a surface of the lithium nickel-based oxide. The lithium nickel-based oxide is in a single particle form having one nodule or in a quasi-single particle form that is a composite of 30 or fewer nodules.

[6] The present disclosure provides the method of preparing a positive electrode active material according to [5], in which the second lithium raw material is mixed in an amount ranging from about 0.2 parts by weight to 0.8 parts by weight based on 100 parts by weight of the prepared lithium nickel-based oxide.

[7] The present disclosure provides the method of preparing a positive electrode active material according to [5] or [6], in which the positive electrode active material satisfies Equation 1:

$$0.078 \leq F \leq 0.082 \qquad [ Equation 1 ]$$

In Equation 1, F is a full width at half maximum (FWHM) of a (104) peak measured by X-ray diffraction (XRD) analysis of the positive electrode active material.

[8] The present disclosure provides the method of preparing a positive electrode active material according to at least one of [5] to [7], in which the heat treatment is performed at a temperature ranging from about 735° C. to 790° C.

[9] The present disclosure provides a positive electrode including the positive electrode active material according to at least one of [1] to [4].

[10] The present disclosure provides a lithium secondary battery including: the positive electrode according to at least one of [1] to [4]; a negative electrode disposed to face the positive electrode; a separator interposed between the positive electrode and the negative electrode; and an electrolyte.

The positive electrode active material according to the present disclosure includes lithium nickel-based oxide particles in which a molar ratio of nickel among total transition metals ranges from about 50 mol % to 70 mol %, and a cobalt coating layer formed on a surface of the lithium nickel-based oxide particles. The positive electrode active material has a full width at half maximum (FWHM) of a (104) peak measured by X-ray diffraction (XRD) analysis ranging from about 0.078 to 0.082.

The lithium nickel-based oxide particles of the positive electrode active material according to the present disclosure are single-particle-type particles, which may reduce side reactions with an electrolyte and have excellent particle strength, which may result in reduced particle breakage and improved energy density. In the present disclosure, cobalt raw material and lithium raw material are mixed together with the lithium nickel-based oxide particles, and the temperature is controlled within a specific range, so that the cobalt raw material and lithium react to form a coating layer having an LCO-like phase on a surface of the positive electrode active material, which may reduce a rock salt phase on the surface of the positive electrode active material. As a result, the surface stability of the positive electrode active material may be improved, and the resistance characteristics at low temperature may be improved.

In addition, the positive electrode and the lithium secondary battery including the positive electrode active material may have excellent energy density, resistance characteristics, and electrochemical performance while reducing the amount of gas generation and may exhibit excellent safety and lifespan characteristics.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 is a flowchart illustrating a method for preparing a positive electrode active material according to an embodiment of the present disclosure.

FIG. 2 is a schematic view illustrating the structure of a positive electrode according to an embodiment of the present disclosure.

FIG. 3 is a schematic view illustrating the structure of a lithium secondary battery according to an embodiment of the present disclosure.

FIG. 4 is an XRD graph of positive-electrode active materials prepared in Examples 1 to 3 of the present disclosure and Comparative Examples 1 to 5.

FIG. 5 is a graph illustrating an enlarged view of the (104) peak in FIG. 4.

FIG. 6 is a DSC graph illustrating measurement results obtained using Example 1 of the present disclosure, Comparative Example 1, and Comparative Example 5.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

The terms or words used in the specification and claims should not be construed as limited to their ordinary or dictionary meanings, but should be construed as having meanings and concepts consistent with the technical idea of the present disclosure based on the principle that an inventor may appropriately define the concepts of terms in order to explain his or her own invention in the best way.

As used herein, terms such as “include,” “comprise,” or “have,” are intended to specify the presence of stated features, numbers, steps, components, or combinations thereof, but are to be understood as not precluding the possibility of the presence or addition of one or more other features, numbers, steps, components, or combinations thereof.

As used herein, each of the expressions such as “A or B,” “at least one of A and B,” “at least one of A or B,” “A, B, or C,” “at least one of A, B, and C,” and “at least one of A, B, or C” may include any one of the items listed in the corresponding expression or any possible combinations thereof.

As used herein, the term “single-particle-type” refers to a particle composed of 30 or fewer nodules and refers to a concept including a single particle composed of one nodule and a quasi-single particle, which is a composite of two to thirty nodules.

The term “nodule” refers to a sub-particle unit constituting a single particle or a quasi-single particle, which may be either a single crystal having no crystalline grain boundary or a polycrystal in which grain boundaries are not visually observed at a magnification of about 5,000× to 20,000× using a scanning electron microscope.

As used herein, the term “secondary particle” refers to a particle formed by aggregation of a plurality of primary particles, for example, several tens to several hundreds of primary particles. For example, the secondary particle may be an aggregate of 5,031 or more primary particles.

As used herein, the term “particle” is a concept including any one or all of a single particle, a quasi-single particle, a primary particle, a nodule, and a secondary particle.

In the present disclosure, an average particle diameter (Dmean) of nodules or primary particles refers to an arithmetic average value calculated after measuring the particle diameters of nodules or primary particles observed in an image obtained by a scanning electron microscope (SEM) or an electron backscatter diffraction (EBSD) analyzer. For example, the particle diameter of nodules or primary particles may be measured under the following conditions: an electrode is fabricated using a powder of the positive electrode active material to be measured, and the unrolled electrode is cut by ion milling (e.g., IM-500 manufactured by HITACHI, acceleration voltage: 6 kV) to obtain a cross-section, followed by measurement under conditions of an acceleration voltage of 15 kV and a working distance (W.D.) of 15 mm using a field emission scanning electron microscope (FE-SEM) (e.g., JSM7900F manufactured by JEOL) with a scale corresponding to approximately 400±10 primary particles.

As used herein, the terms “about,” “approximately,” and “substantially” are used to mean a range of the numerical value or degree, or a value close thereto, in consideration of inherent manufacturing and material tolerances (e.g., ±5%).

As a positive electrode active material for a lithium secondary battery, lithium cobalt oxide (LiCoO₂), lithium nickel oxide (LiNiO₂), lithium manganese oxide (e.g., LiMnO₂ or LiMn₂O₄), and lithium iron phosphate compound (LiFePO₄) have been used. In order to overcome the problems of lithium transition metal oxides including Ni, Co, or Mn alone, lithium composite transition metal oxides including two or more transition metals have been developed, among which lithium nickel cobalt manganese oxide including Ni, Co, and Mn is widely used in the field of batteries for electric vehicles.

Conventional lithium nickel cobalt manganese oxides are generally in the form of spherical secondary particles formed by aggregation of several tens to several hundreds of primary particles. However, when a lithium nickel cobalt manganese oxide in the form of secondary particles in which a large number of primary particles are aggregated is applied to a positive electrode, particle breakage may easily occur during a rolling process in positive electrode fabrication due to separation of the primary particles, and cracks may occur inside the particles during charging and discharging processes. When particle breakage or cracking of the positive electrode active material occurs, the contact area with the electrolyte increases, leading to an increase in gas generation and degradation of the active material due to side reactions with the electrolyte, which may result in deterioration in lifespan characteristics.

In order to solve the above-described problems, a technique has been proposed for producing a single-particle-type positive electrode active material, rather than secondary particles, by increasing the calcination temperature during the preparation of lithium nickel cobalt manganese oxide. In the case of a single-particle-type positive electrode active material, the contact area with an electrolyte is smaller than that of a conventional secondary-particle-type positive electrode active material, resulting in fewer side reactions with the electrolyte and less particle breakage during electrode fabrication due to excellent particle strength. Accordingly, when a single-particle-type positive electrode active material is applied, excellent gas generation characteristics and lifespan performance are achieved.

However, a conventional single-particle-type positive electrode active material has the effect of enhancing high-temperature durability and reducing gas generation by improving reactivity with the electrolyte through reduced surface area (reaction area) compared to secondary particles, but has a problem in that output performance is reduced due to an increased lithium migration distance.

In addition, the positive electrode may be classified into a high-nickel positive electrode with high capacity or a mid-nickel positive electrode depending on the nickel content. Among them, in the case of a mid-nickel positive electrode having a nickel content of 40% to 70%, there is a problem of higher resistance due to a relatively high manganese content and the particle size of the active material compared to a high-nickel positive electrode. For example, the mid-nickel positive electrode tends to have deteriorated resistance performance under low-temperature conditions.

The present disclosure provides a technique for improving the electrochemical performance of a positive electrode including a single-particle-type mid-nickel active material in consideration of the above-described points.

Hereinafter, the present disclosure will be described in more detail.

The positive electrode active material according to the present disclosure, the method of producing the same, and the positive electrode and lithium secondary battery including the same include at least one of the configurations disclosed below, and may include any combination of the technically feasible configurations among those described below.

### Positive Electrode Active Material

First, the positive electrode active material according to the present disclosure will be described.

The positive electrode active material according to the present disclosure includes lithium nickel-based oxide particles in which a molar ratio of nickel among total transition metals ranges from about 50 mol % to 70 mol %, and a coating layer formed on a surface of the lithium nickel-based oxide particles and including cobalt.

High-nickel active materials, which have been conventionally used as positive electrode active materials for lithium secondary batteries, have a molar ratio of nickel among total transition metals of about 80 mol % or more and provide advantages of excellent capacity and energy density. However, due to the relatively high nickel content, thermal safety is lowered, and structural stability is deteriorated as a result of an increase in highly reactive Ni⁴⁺. Therefore, attention has been focused on mid-nickel active materials having a nickel content ranging from about 40% to 70%. However, when the nickel content decreases and the manganese content relatively increases, resistance increases. For example, there is a problem that resistance characteristics sharply deteriorate at low temperatures.

The positive electrode active material of the present disclosure applies cobalt coating to the surface of single-particle-type lithium nickel-based oxide particles, and by adjusting the temperature during the cobalt coating to optimize the degree of cobalt coating, the resistance characteristics of a lithium secondary battery at low temperatures may be improved when the material is applied to the battery. In addition, by utilizing the fact that the full width at half maximum (FWHM) value of the (104) peak measured by X-ray diffraction (XRD) analysis varies depending on the degree of cobalt coating, the FWHM of the (104) peak of the positive electrode active material with optimized cobalt coating is defined within a specific range. Accordingly, the present disclosure provides a positive electrode active material including lithium nickel-based oxide particles having a nickel molar ratio ranging from about 55 mol % to 70 mol % among the total transition metals and a coating layer formed on the surface of the lithium nickel-based oxide particles, and satisfying the following Equation 1, thereby preventing or suppressing resistance increase caused by a relatively high manganese content in the lithium nickel-based oxide.

The coating layer according to the present disclosure includes cobalt, and when forming the coating layer on the surface of the lithium nickel-based oxide particles, a heat treatment process is carried out within the above-described specific temperature range. The coating layer including cobalt may improve surface stability by reconstructing the rock salt phase of the lithium nickel-based oxide into a layered structure through surface modification of the lithium nickel-based oxide particles. As a result, the coating layer may prevent or suppress deterioration of resistance characteristics under low-temperature conditions.

The lithium nickel-based oxide particles are in a single-particle-type particle form having one nodule or in a quasi-single particle form that is a composite of single particles or 30 or fewer nodules. Compared with conventional lithium manganese-based oxides having secondary-particle-type structures, the particles have higher particle strength, resulting in less particle breakage during rolling, and the number of sub-particle units constituting the particles is smaller. Therefore, changes due to volume expansion and contraction of the sub-particle units during charge and discharge are reduced, which significantly decreases the occurrence of cracks inside the particles. As particle breakage and internal cracking decrease, the contact area between the lithium nickel-based oxide and the electrolyte becomes smaller. Therefore, dissolution of manganese or nickel caused by reactions with the electrolyte at high temperatures may be suppressed, storage and lifespan characteristics may be improved, and gas generation due to side reactions with the electrolyte may be reduced.

The positive electrode active material according to the present disclosure satisfies the following Equation 1:

$$0.078 \leq F \leq 0.082 \qquad [ Equation 1 ]$$

In Equation 1, F represents the full width at half maximum (FWHM) of a (104) peak measured by X-ray diffraction (XRD) analysis of the positive electrode active material.

In an embodiment, the measurement conditions were based on Cu-Kα radiation, and an X-ray diffraction pattern was obtained by measuring a 2θ range of 43.0° to 45.5° at 40 kV. For example, the full width at half maximum refers to the FWHM of the (104) peak observed at 44.5±1.0° (2θ). In the XRD analysis, a Cu Kα₁ radiation source was used as the X-ray source, and the measurement was performed in a θ-2θ scan (Bragg-Brentano parafocusing geometry) mode over a 2θ range of 10° to 120° with a step interval of 0.02°. The FWHM of the (104) peak was calculated by fitting a Lorentz function, and the fitting for FWHM measurement using the Lorentz function may be performed using various publicly available or commercial software known to those skilled in the art.

In Equation 1, the (104) peak refers to the peak intensity of the (104) plane in the X-ray diffraction graph of the positive electrode active material, and the full width at half maximum represents the width of the peak at a position corresponding to half of the peak height. F may represent the structural characteristics of the positive electrode active material having a coating layer, and when F satisfies the above range, it indicates that an optimized coating layer is formed on the surface of the lithium nickel-based oxide particles. The peak of the (104) plane represents the repeated layered arrangement characteristics in the c-axis direction in the crystal structure of the positive electrode active material, which may indicate that the degree of reconstruction of the surface of the lithium nickel-based oxide particles from a rock salt phase to a layered structure is optimized due to the cobalt coating. For example, the cobalt coating reconstructs the surface of the lithium nickel-based oxide particles from a rock salt phase to a layered structure, and the degree of reconstruction may vary depending on, for example, the cobalt raw material, lithium content, and temperature. For example, during cobalt coating, if the lithium is insufficient when the cobalt raw material, such as Co₃O₄, reacts with lithium, unreacted Co₃O₄ may remain, resulting in a reduced reconstruction effect. Consequently, the layered structure may not be sufficiently formed, leading to deterioration of surface stability.

The lithium nickel-based oxide particles according to the present disclosure may have a nickel molar ratio ranging from about 50 mol % to 70 mol % among total transition metals, for example, from about 60 mol % to 70 mol %. When the nickel content satisfies the above range, a decrease in capacity characteristics may be prevented or suppressed while minimizing deterioration of lifespan characteristics during high-voltage operation. According to an embodiment, the nickel content may be about 50 mol % or more, about 55 mol % or more, or about 60 mol % or more, and may also be about 70 mol % or less or about 65 mol % or less.

The lithium-nickel-based oxide particles according to the present disclosure may be represented by Formula 1:

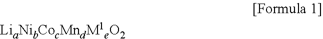

In Formula 1, M¹ may be one or more elements selected from Al, Ba, Zr, Ti, Ta, Nb, Y, W, Sr, B, Mg, Mo, Ce, F, and P. When the lithium nickel-based oxide particles include the M¹ element, structural stability of the lithium nickel-based oxide particles may be enhanced, thereby implementing excellent lifespan characteristics during high-voltage operation. According to an embodiment, the M¹ element may include one or more elements selected from Ti, Mg, Al, Zr, W, and Y, or may include two or more selected from Ti, Mg, Al, Zr, W, and Y.

In Chemical Formula 1, the symbol “a” represents a molar ratio of lithium in the lithium nickel-based oxide, and may satisfy 0.9≤a≤1.1, 0.95≤a≤1.1, or 1.0≤a≤1.08. When the value of “a” satisfies the above range, a stable layered crystal structure may be formed.

The symbol “b” represents a molar ratio of nickel among total metals except lithium in the lithium nickel-based oxide, and may satisfy 0.5≤b≤0.7, 0.55≤b≤0.7, or 0.6≤b≤0.7. When the value of “b” satisfies the above range, excellent high-temperature and/or high-voltage stability may be achieved.

The symbol “c” represents a molar ratio of cobalt among total metals except lithium in the lithium nickel-based oxide, and may satisfy 0<c<0.5, 0.05≤c≤0.4, or 0.1≤c≤0.4.

The symbol “d” represents a molar ratio of manganese among total metals except lithium in the lithium nickel-based oxide, and may satisfy 0<d<0.5, 0.05≤d≤0.4, or 0.1≤d≤0.4.

The symbol “e” represents a molar ratio of the M¹ element among total metals except lithium in the lithium nickel-based oxide, and may satisfy 0≤e≤0.2, 0≤e≤0.1, or 0<e≤0.1. When the molar ratio of the M¹ element satisfies the above range, both structural stability and capacity of the positive electrode active material may be excellent.

In the present disclosure, the cobalt content included in the coating layer may range from about 1 mol % to 5 mol % based on 100 mol of the lithium nickel-based oxide, for example, from about 1 mol % to 4 mol %, or from about 2 mol % to 4 mol %. When the cobalt content in the coating layer satisfies the above range, the resistance of the lithium secondary battery at low temperatures may be reduced as a result of an increased cobalt coating content.

### Method for Producing Positive Electrode Active Material

Next, a method for producing a positive electrode active material according to the present disclosure will be described.

When producing a single-particle-type positive electrode active material in which the molar ratio of Ni among total transition metals ranges from about 50% to 70%, resistance may increase due to an increase in the lithium path. In addition, when the particle size is reduced to decrease the resistance, problems such as an increase in gas generation may occur, making it difficult to achieve the advantages of single particles. Accordingly, the method for producing a positive electrode active material according to the present disclosure may improve structural stability by forming a coating layer on the surface of a lithium nickel-based oxide and may improve resistance characteristics while exhibiting the effects of preventing particle breakage and enhancing lifespan characteristics, which are the advantages of single particles, through optimization of coating conditions.

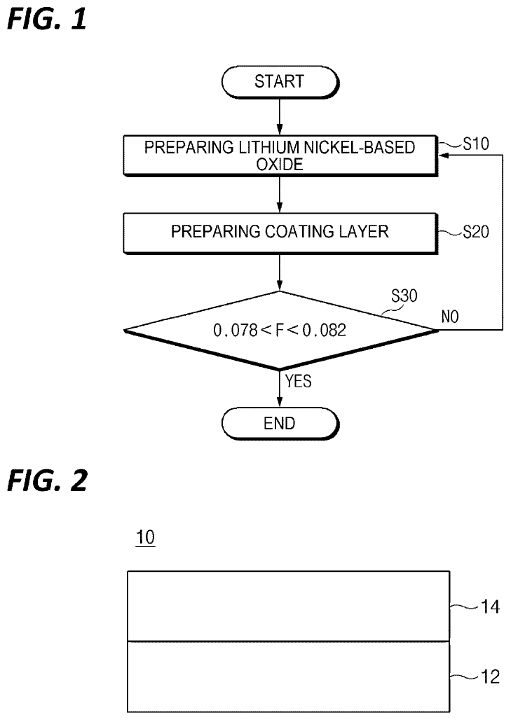

FIG. 1 is a flowchart illustrating a method for producing a positive electrode active material according to an embodiment of the present disclosure.

Referring to FIG. 1, the method for producing a positive electrode active material according to the present disclosure includes: a step of mixing a transition metal precursor including nickel, cobalt, and manganese with a first lithium raw material, followed by calcination, to prepare a lithium nickel-based oxide (S10); and a step of mixing the prepared lithium nickel-based oxide with a cobalt raw material and a second lithium raw material, and performing heat treatment to prepare a positive electrode active material including a coating layer on a surface of the lithium nickel-based oxide (S20). In this case, in the method for producing a positive electrode active material, an optimized coating layer may be formed by adding the second lithium raw material during the coating layer formation and adjusting the coating temperature within a specific range. The method for producing a positive electrode active material according to the present disclosure may further include a step of verifying whether the full width at half maximum (FWHM) value of the (104) peak, measured by X-ray diffraction (XRD) analysis on the positive electrode active material including the coating layer, falls within a specific range (S30).

When the full width at half maximum (FWHM) value measured in step (S30) does not fall within the range according to an embodiment, for example, from 0.078 to 0.082, the process may return to step (S20) to adjust the coating layer formation conditions, such as heat treatment conditions. Meanwhile, the conditions of forming the coating layer may be adjusted not only by controlling the heat treatment temperature but also by other conditions, for example, by adjusting the amount of the cobalt raw material or the amount of the lithium raw material added during the coating layer formation.

The lithium nickel-based oxide may be in a single particle form having one nodule or in a quasi-single particle form that is a composite of 30 or fewer nodules, and the positive electrode active material satisfies Equation 1:

$$0.078 \leq F \leq 0.082 \qquad [ Equation 1 ]$$

In Equation 1, F represents the full width at half maximum (FWHM) of a (104) peak measured by X-ray diffraction (XRD) analysis of the positive electrode active material. The above description applies in the same manner as previously described, and therefore, redundant explanations are omitted.

The respective steps will now be described in more detail below.

The step of preparing the lithium nickel-based oxide (S10) may be performed by mixing a transition metal precursor including nickel, cobalt, and manganese with a first lithium raw material, followed by calcination.

The transition metal precursor may be a commercially available precursor, such as a nickel-cobalt-manganese hydroxide, or a precursor prepared by a method known in the art, such as a coprecipitation method.

For example, a transition metal precursor may be prepared by preparing a transition metal-containing solution including nickel (Ni) and cobalt (Co) cations, and then adding an ammonium cation-containing complexing agent and a basic aqueous solution to the transition metal-containing solution to cause a coprecipitation reaction.

The first lithium raw material may include lithium-containing sulfates, nitrates, acetates, carbonates, oxalates, citrates, halides, hydroxides, or oxyhydroxides, and is not particularly limited as long as it is soluble in water. For example, the lithium raw material may be Li₂CO₃, LiNO₃, LiNO₂, LiOH, LiOH·H₂O, LiH, LiF, LiCl, LiBr, LiI, CH₃COOLi, LizO, Li₂SO₄, or Li₃C₆H₅O₇, and one or more mixtures thereof may be used.

The transition metal precursor and the lithium raw material may be mixed, for example, at a molar ratio of about 1:1, about 1:1.05, about 1:1.10, about 1:1.15, or about 1:1.20, but are not limited thereto.

The subsequent step of preparing the positive electrode active material is a step of forming a coating layer on the prepared lithium nickel-based oxide (S20). Specifically, the prepared lithium nickel-based oxide may be mixed with a cobalt raw material and a second lithium raw material and subjected to heat treatment to form a coating layer on the surface of the lithium nickel-based oxide. By mixing the second lithium raw material during the heat treatment step to compensate for lithium, the low-temperature output characteristics and resistance characteristics of the lithium secondary battery may be improved.

According to an embodiment, the heat treatment may be performed at a temperature ranging from about 735° C. to 790° C., for example, from about 740° C. to 785° C., or from about 745° C. to 785° C. When the heat treatment temperature satisfies the above range, a positive electrode with excellent low-temperature resistance and lifespan performance may be implemented by forming an optimized coating layer. The optimized coating layer refers to a coating layer formed by sufficient reaction between lithium and cobalt. Accordingly, the heat treatment temperature according to an embodiment may be about 735° C. or higher, 740° C. or higher, 745° C. or higher, 755° C. or higher, 760° C. or higher, or 765° C. or higher, and may also be about 790° C. or lower, 780° C. or lower, 775° C. or lower, or 770° C. or lower. According to an embodiment, in addition to performing the heat treatment under the above-described temperature range, other conditions, for example, the amount of the cobalt raw material and/or the second lithium raw material, may also be adjusted to form the coating layer.

In this case, the type of the second lithium raw material may be the same as or different from that of the first lithium raw material. For example, the second lithium raw material may be a lithium-containing sulfate, nitrate, acetate, carbonate, oxalate, citrate, halide, hydroxide, or oxyhydroxide, and is not particularly limited as long as it is soluble in water. For example, the lithium raw material may be Li₂CO₃, LiNO₃, LiNO₂, LiOH, LiOH·H₂O, LiH, LiF, LiCl, LiBr, LiI, CH₃COOLi, Li₂O, Li₂SO₄, or Li₃C₆H₅O₇, and one or more mixtures thereof may be used.

According to an embodiment, the second lithium raw material may be included in an amount ranging from about 0.2 parts by weight to 0.8 parts by weight, for example, about 0.2 parts by weight to 0.6 parts by weight, based on 100 parts by weight of the prepared lithium nickel-based oxide. When the content of the second lithium raw material satisfies the above range, an LCO-like phase may be appropriately formed on the surface of the lithium nickel-based oxide particles to reduce the resistance of the lithium secondary battery at about −10° C. Accordingly, the content of the second lithium raw material may be about 0.2 parts by weight or more, or about 0.3 parts by weight or more, and may also be about 0.8 parts by weight or less or about 0.7 parts by weight or less.

The cobalt raw material may include a cobalt-containing acetate, nitrate, sulfate, halide, sulfide, hydroxide, oxide, or oxyhydroxide, for example, Co(OH)₂, CoOOH, Co(OCOCH₃)₂·4H₂O, Co(NO₃)₂·6H₂O, CoSO₄, Co(SO₄)₂·7H₂O, or a combination thereof, but is not limited thereto.

The mixing method of the cobalt raw material, the second lithium raw material, and the lithium nickel-based oxide is not particularly limited and may be performed by dry mixing or wet mixing. For example, the coating raw material in a solid phase and the lithium nickel-based oxide in a solid phase may be dry-mixed with stirring by placing the coating raw material and the lithium nickel-based oxide in a mixer, or may be wet-mixed with stirring by adding the coating raw material and the lithium nickel-based oxide to a solvent such as water or ethanol.

### Positive Electrode

FIG. 2 is a schematic view illustrating the structure of a positive electrode according to an embodiment of the present disclosure.

Referring to FIG. 2, the positive electrode 10 according to the present disclosure includes the above-described positive electrode active material. The positive electrode includes a positive electrode current collector 12 and a positive electrode composite layer 14 positioned on the positive electrode current collector 12. The positive electrode composite layer 14 may include a positive electrode active material, a binder, and a conductive material. Since the positive electrode active material is the same as the positive electrode active material according to the present disclosure described above, a detailed description thereof will be omitted, and the following description will focus on the other components except the positive electrode active material.

The positive electrode current collector 12 is not particularly limited as long as it has conductivity and does not cause a chemical change in the battery. For example, stainless steel, aluminum, nickel, titanium, sintered carbon, or a material obtained by treating the surface of aluminum or stainless steel with, for example, carbon, nickel, titanium, or silver may be used as the positive electrode current collector 12.

The binder is a component that assists in binding the positive electrode active material and the conductive material, as well as in binding them to the current collector. Examples of such binders include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene (PE), polypropylene, ethylene-propylene-diene monomer, sulfonated ethylene-propylene-diene monomer, styrene-butadiene rubber, fluorine rubber, and various copolymers.

According to an embodiment, the binder may be included in an amount ranging from about 1 wt % to 20 wt %, for example, about 1 wt % to 15 wt %, or about 1 wt % to 10 wt %, based on the total weight of the positive electrode composite layer 14.

The conductive material is a component for further improving the conductivity of the positive electrode active material, and is not particularly limited as long as it has conductivity and does not cause a chemical change in the battery. Examples of the conductive material may include: carbon powders such as carbon black, acetylene black, Ketjen black, channel black, furnace black, lamp black, or thermal black; graphite powders such as natural graphite, artificial graphite, or graphite with a highly developed crystal structure; conductive fibers such as carbon fibers or metal fibers; fluorinated carbon; conductive powders such as aluminum powder or nickel powder; conductive whiskers such as zinc oxide or potassium titanate; conductive metal oxides such as titanium oxide; and conductive materials such as polyphenylene derivatives.

According to an embodiment, the conductive material may be included in an amount ranging from about 1 wt % to 20 wt %, for example, about 1 wt % to 15 wt %, or about 1 wt % to 10 wt %, based on the total weight of the positive electrode composite layer.

The positive electrode composite layer 14 may be prepared by applying and drying a positive electrode slurry composition prepared by dissolving or dispersing the positive electrode active material, and optionally a binder and a conductive material, in a positive electrode slurry solvent on the positive electrode current collector 12, or by casting the positive electrode slurry composition on a separate support, peeling off a film obtained therefrom, and laminating the film onto the positive electrode current collector 12.

The positive electrode slurry solvent may include an organic solvent such as dimethyl sulfoxide (DMSO), isopropyl alcohol, N-methyl-2-pyrrolidone (NMP), or acetone, and may be used in an amount suitable for achieving an appropriate viscosity when including, for example, the positive electrode active material, the binder, and the conductive material. According to an embodiment, the positive electrode slurry solvent may be included so that the concentration of solid content, including the positive electrode active material and optionally the binder and the conductive material, is about 50 wt % to 95 wt %, 70 wt % to 95 wt %, or 70 wt % to 90 wt %.

### Lithium Secondary Battery

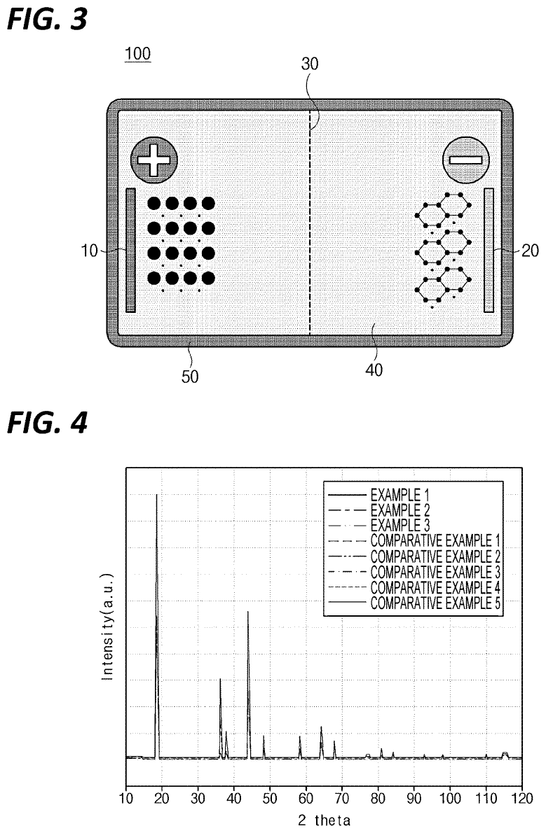

FIG. 3 is a schematic view illustrating the structure of a lithium secondary battery according to an embodiment of the present disclosure.

Referring to FIG. 3, the lithium secondary battery 100 according to an embodiment of the present disclosure includes an electrode assembly including the above-described positive electrode 10, a negative electrode 20 disposed to face the positive electrode 10, and a separator 30 interposed between the positive electrode 10 and the negative electrode 20, a non-aqueous electrolyte 40, and a battery case 50 accommodating the electrode assembly and the non-aqueous electrolyte 40. Since the positive electrode 10 is the same as the positive electrode according to the present disclosure described above, a detailed description thereof will be omitted, and the following description will focus on the other components except the positive electrode 10.

The lithium secondary battery 100 may be manufactured by accommodating the electrode assembly in the battery case 50 and then injecting the non-aqueous electrolyte 40 described above into the battery case.

The lithium secondary battery 100 according to an embodiment of the present disclosure may be manufactured, depending on its shape, in a prismatic type, pouch type, coin type, or cylindrical type.

### (1) Negative Electrode

In the lithium secondary battery 100 according to the present disclosure, the negative electrode 20 includes a negative electrode current collector and a negative electrode composite layer positioned on the negative electrode current collector. The negative electrode composite layer may include a negative electrode active material, a binder, and a conductive material.

The negative electrode current collector is not particularly limited as long as it has high conductivity and does not cause a chemical change in the battery. For example, copper, stainless steel, aluminum, nickel, titanium, heat-treated carbon, a material obtained by treating the surface of copper or stainless steel with carbon, nickel, titanium, or silver, or an aluminum-cadmium alloy may be used.

The negative electrode current collector may generally have a thickness ranging from about 3 μm to 500 μm, and may have a thickness of, for example, about 300 μm or less, 200 μm or less, 100 μm or less, or 80 μm or less. A fine uneven structure may be formed on the surface of the current collector to enhance the binding force with the negative electrode active material. For example, the negative electrode current collector may be used in various forms such as a film, a sheet, a foil, a net, a porous body, a foam body, and a nonwoven material.

The negative electrode active material may include a compound capable of reversible intercalation and deintercalation of lithium and may include at least one selected from a carbon-based active material and a silicon-based active material. For example, the carbon-based active material may include at least one selected from artificial graphite, natural graphite, soft carbon, and hard carbon. In addition, the silicon-based active material may include at least one selected from silicon (Si), silicon oxide (SiOₓ, 0<x<2), and a silicon-carbon composite (Si/C composite), and more suitably may include a silicon-carbon composite.

The negative electrode active material may be included in an amount ranging from about 60 wt % to 99 wt % based on the total weight of the negative electrode composite layer, and may be included in an amount of, for example, about 70 wt % or more, 80 wt % or more, 85 wt % or more, or 90 wt % or more, and about 98 wt % or less, 97 wt % or less, or 95 wt % or less.

The binder is a component that assists in binding among the conductive material, the active material, and the current collector, and may generally be added in an amount ranging from about 0.1 wt % to 10 wt % based on the total weight of the negative electrode composite layer, and may be included in an amount of about 0.2 wt % or more, 0.3 wt % or more, or 0.5 wt % or more, and about 8.0 wt % or less, or 5.0 wt % or less. Examples of such binders may include at least one selected from a styrene-butadiene copolymer, an acrylate-styrene-butadiene copolymer, an acrylonitrile-butadiene copolymer, an acrylonitrile-butadiene-styrene copolymer, an acrylic rubber, butyl rubber, fluorine rubber, polytetrafluoroethylene, polyethylene, polypropylene, an ethylene-propylene copolymer, polyethylene oxide, polyvinylpyrrolidone, polyepichlorohydrin, polyphosphazene, polyacrylonitrile, polystyrene, an ethylene-propylene-diene copolymer, polyvinylpyridine, chlorosulfonated polyethylene, latex, polyester resin, acrylic resin, phenol resin, epoxy resin, and polyvinyl alcohol. Among these, at least one selected from a styrene-butadiene copolymer, an acrylate-styrene-butadiene copolymer, an acrylonitrile-butadiene copolymer, an acrylonitrile-butadiene-styrene copolymer, carboxymethyl cellulose, hydroxypropyl methyl cellulose, hydroxypropyl cellulose, diacetyl cellulose, cellulose acetate butyrate, cellulose acetate propionate, cyanoethyl pullulan, cyanoethyl polyvinyl alcohol, cyanoethyl cellulose, and cyanoethyl sucrose may be included. According to an embodiment, carboxymethyl cellulose, hydroxypropyl methyl cellulose, hydroxypropyl cellulose, or a mixture thereof may be used as the binder.

The conductive material is a component for further improving the conductivity of the negative electrode active material and may be added in an amount of about 10 wt % or less, for example, about 5 wt % or less, 3 wt % or less, 2 wt % or less, or 1 wt % or less, based on the total weight of the negative electrode composite layer. In addition, it may be included in an amount of about 0.01 wt % or more, 0.05 wt % or more, 0.08 wt % or more, 0.1 wt % or more, or 0.3 wt % or more.

Such a conductive material is not particularly limited as long as it has conductivity and does not cause a chemical change in the battery. For example, graphite such as natural graphite or artificial graphite; carbon black such as acetylene black, Ketjen black, channel black, furnace black, lamp black, or thermal black; conductive fibers such as carbon fibers or metal fibers; fluorinated carbon; metallic powders such as aluminum or nickel powders; conductive whiskers such as zinc oxide or potassium titanate; conductive metal oxides such as titanium oxide; and conductive materials such as polyphenylene derivatives may be used.

The negative electrode composite layer may be prepared by applying and drying a negative electrode slurry composition prepared by dissolving or dispersing the negative electrode active material, and optionally a binder and a conductive material, in a negative electrode slurry solvent on the negative electrode current collector, or by casting the negative electrode slurry composition on a separate support, peeling off a film obtained therefrom, and laminating the film onto the negative electrode current collector.

The negative electrode slurry solvent may include, for example, at least one selected from distilled water, N-methyl-2-pyrrolidone (NMP), ethanol, methanol, and isopropyl alcohol, for facilitating the dispersion of the negative electrode active material, the binder, and/or the conductive material, and may include, for example, distilled water. The solid content concentration of the negative electrode slurry composition may range from about 30 wt % to 80 wt %, for example, from about 40 wt % to 70 wt %.

### (2) Separator

The separator according to the present disclosure separates the negative electrode and the positive electrode and provides a pathway for the movement of lithium ions, and may be used without particular limitation as long as it is a separator commonly used in lithium secondary batteries. Specifically, the separator may be a porous polymer film made of a polyolefin-based polymer, such as an ethylene homopolymer, a propylene homopolymer, an ethylene/butene copolymer, an ethylene/hexene copolymer, or an ethylene/methacrylate copolymer, or a laminated structure including two or more layers thereof. In addition, conventional porous non-woven fabrics such as non-woven fabrics made of, for example, high melting point glass fiber or polyethylene terephthalate fiber may be used. Furthermore, a coated separator including a ceramic component or a polymer material may be used to ensure heat resistance or mechanical strength.

### (3) Electrolyte

The electrolyte 40 used in the present disclosure may include, without limitation, an organic liquid electrolyte, an inorganic liquid electrolyte, a solid polymer electrolyte, a gel-type polymer electrolyte, a solid inorganic electrolyte, or a molten inorganic electrolyte that is usable in manufacturing a lithium secondary battery 100.

According to an embodiment, the electrolyte 40 may include an organic solvent and a lithium salt. The organic solvent may be used without particular limitation as long as it serves as a medium that allows ions involved in the electrochemical reactions of the battery to move therethrough. Examples of the organic solvent may include: ester-based solvents such as methyl acetate, ethyl acetate, γ-butyrolactone, and &-caprolactone; ether-based solvents such as dibutyl ether and tetrahydrofuran; ketone-based solvents such as cyclohexanone; aromatic hydrocarbon-based solvents such as benzene and fluorobenzene; carbonate-based solvents such as dimethyl carbonate (DMC), diethyl carbonate (DEC), ethyl methyl carbonate (EMC), ethylene carbonate (EC), and propylene carbonate (PC); alcohol-based solvents such as ethyl alcohol and isopropyl alcohol; nitriles such as R-CN (where R is a straight-chain, branched, or cyclic hydrocarbon group having 2 to 20 carbon atoms and may include a double bond or an ether bond); amides such as dimethylformamide; dioxolanes such as 1,3-dioxolane; or sulfolanes. According to an embodiment, a carbonate-based solvent may be used, and a mixture of a cyclic carbonate compound having high ionic conductivity and high dielectric constant (e.g., ethylene carbonate or propylene carbonate) to enhance charge/discharge performance, and a low-viscosity linear carbonate compound (e.g., ethyl methyl carbonate, dimethyl carbonate, or diethyl carbonate) may be used.

The lithium salt may be used without particular limitation as long as it is a compound capable of providing lithium ions for use in a lithium secondary battery. Examples of anions of the lithium salt may include one or more selected from F⁻, Cl⁻, Br⁻, I⁻, NO₃⁻, N(CN)₂⁻, BF₄⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻. Examples of the lithium salt may include LiPF₆, LiClO₄, LiAsF₆, LiBF₄, LiSbF₆, LiAlO₄, LiAlCl₄, LiCF₃SO₃, LiCAF₉SO₃, LiN(C₂F₅SO₃)₂, LiN(C₂F₅SO₂)₂, LiN(CF₃SO₂)₂, LiCl, LiI, or LiB(C₂O₄)₂. The concentration of the lithium salt may range from about 0.1 M to 4.0 M, for example, from about 0.5 M to 3.0 M, or from about 1.0 M to 2.0 M. When the concentration of the lithium salt is within the above-mentioned ranges, the electrolyte has appropriate conductivity and viscosity to enable excellent electrolyte performance and to allow lithium ions to effectively migrate.

In addition to the components of the electrolyte described above, the electrolyte may further include at least one additive for purposes such as improving the lifespan characteristics of the battery, preventing a decrease in battery capacity, or enhancing the discharge capacity of the battery. Examples of such an additive may include: haloalkylene carbonate compounds such as difluoroethylene carbonate; pyridine; triethyl phosphite; triethanolamine; cyclic ethers; ethylenediamine; n-glyme; hexamethylphosphoramide; nitrobenzene derivatives; sulfur; quinone imine dyes; N-substituted oxazolidinones; N,N-substituted imidazolidines; ethylene glycol dialkyl ethers; ammonium salts; pyrrole; 2-methoxyethanol; or aluminum trichloride. In this case, the additive may be included in an amount ranging from about 0.1 wt % to 10.0 wt % based on the total weight of the electrolyte.

In addition, since the lithium secondary battery 100 according to the present disclosure stably exhibits excellent discharge capacity, output characteristics, and capacity retention rate, it is useful for portable devices such as mobile phones, notebook computers, and digital cameras, as well as for electric vehicles such as hybrid electric vehicles (HEVs).

Accordingly, another embodiment of the present disclosure may provide a battery module including the above-described lithium secondary battery as a unit cell, and a battery pack including the battery module.

The battery module or the battery pack may be used as a power source for one or more medium- or large-sized devices such as power tools, electric vehicles (EVs) including hybrid electric vehicles (HEVs) and plug-in hybrid electric vehicles (PHEVs), or power storage systems.

Hereinafter, the disclosure will be described in more detail with reference to examples. However, the present disclosure is not limited to the embodiments described herein and may be implemented in various other forms.

### Example 1

### (Preparation of Positive Active Material)

A lithium nickel-based oxide was prepared by mixing a transition-metal precursor having a molar ratio of Ni:Co:Mn=63:7:30 and a first lithium raw material (Li₂CO₃) so that the molar ratio of the transition metals (Ni+Co+Mn) to Li became 1:1.06 and performing calcination at 920° C. for 12 hours.

Subsequently, a single-particle positive electrode active material having a cobalt coating layer was prepared by adding a cobalt raw material (CoOOH, 3 mol %) and a second lithium raw material (Li₂CO₃, 0.6 wt %) to the lithium nickel-based oxide and performing heat treatment on the mixture at 765° C. for 10 hours.

### Example 2

Except that the heat treatment for forming the cobalt coating layer was performed at 745° C., the positive-electrode active material was prepared in the same manner as in Example 1.

### Example 3

Except that the heat treatment for forming the cobalt coating layer was performed at 785° C., the positive-electrode active material was prepared in the same manner as in Example 1.

### Comparative Example 1

Except that the second lithium raw material was not added, the positive-electrode active material was prepared in the same manner as in Example 1.

### Comparative Example 2

Except that the heat treatment for forming the cobalt coating layer was performed at 685° C., the positive-electrode active material was prepared in the same manner as in Example 1.

### Comparative Example 3

Except that the heat treatment for forming the cobalt coating layer was performed at 705° C., the positive-electrode active material was prepared in the same manner as in Example 1.

### Comparative Example 4

Except that the heat treatment for forming the cobalt coating layer was performed at 805° C., the positive-electrode active material was prepared in the same manner as in Example 1.

### Comparative Example 5

Except that a transition-metal precursor having a molar ratio of Ni:Co:Mn=86:7:7 was used to prepare the lithium nickel-based oxide, the positive-electrode active material was prepared in the same manner as in Example 1.

### Experimental Example 1: XRD Analysis of Positive-Electrode Active Materials

In order to comparatively analyze the coating layers included in the positive-electrode active materials prepared in Examples 1 to 3 and Comparative Examples 1 to 5, X-ray diffraction (XRD) analysis was performed for each of the positive-electrode active materials using a D8_Endeavor instrument (available from Bruker).

For example, XRD analysis graphs were obtained by measuring in the 20 range of 35° to 50° at 40 kV using Cu-Kα₁ radiation, and the results are shown in FIG. 4. The full width at half maximum (FWHM) of the (104) peak measured at 2θ=43.0° to 45.5° was calculated.

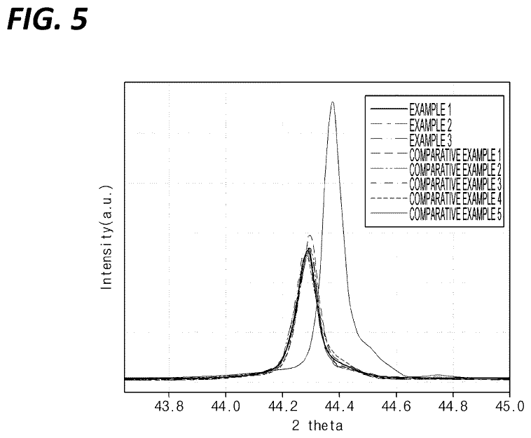

The full width at half maximum refers to the FWHM of the (104) peak observed at 44.5±1.0° (2θ). In the XRD analysis, a Cu Kai radiation source was used as the X-ray source, and the measurement was performed in a θ-2θ scan (Bragg-Brentano parafocusing geometry) mode over a 20 range of 10° to 120° with a step interval of 0.02°. The FWHM of the (104) peak was determined by Lorentz function fitting, and the results are shown in FIG. 5 and Table 1 below.

TABLE 1

| | FWHM |
|---|---|
| Example 1 | 0.07845 |
| Example 2 | 0.078 |
| Example 3 | 0.07928 |
| Comparative Example 1 | 0.07493 |
| Comparative Example 2 | 0.0776 |
| Comparative Example 3 | 0.07759 |
| Comparative Example 4 | 0.08349 |
| Comparative Example 5 | 0.07042 |

The FWHM values of Examples 1 to 3, in which the heat treatment for forming the coating layer was performed at temperatures between 735° C. to 790° C., were 0.07845, 0.078, and 0.07928, respectively, showing values ranging from 0.078 to 0.082.

### Experimental Example 2: Measurement of Low-Temperature Performance of Lithium Secondary Battery

The low-temperature performance of lithium secondary batteries prepared as described below was evaluated using the positive-electrode active materials prepared in Examples 1 to 3 and Comparative Examples 1 to 4.

### <Preparation of Lithium Secondary Battery>

Positive-electrode slurries were prepared by mixing the positive-electrode active materials prepared in respective Examples 1 to 3 and Comparative Examples 1 to 4, a conductive material (carbon black), and a PVDF binder in a weight ratio of 95:2:3 in N-methyl-2-pyrrolidone (NMP). The positive-electrode slurries were applied onto one surface of an aluminum current collector, dried at 130° C., and then rolled to prepare positive electrodes.

Subsequently, a separator was interposed between the positive electrode and a lithium metal electrode to prepare an electrode assembly. The electrode assembly was then placed in a battery case, and an electrolyte was injected into the case to manufacture a lithium secondary battery in the form of a coin half-cell. The electrolyte was prepared by dissolving LiPF₆ at a concentration of 0.6 M in a mixed organic solvent obtained by mixing ethylene carbonate (EC), dimethyl carbonate (DMC), and ethyl methyl carbonate (EMC) in a volume ratio of 1:2:1.

### (1) Capacity Measurement

Using the positive-electrode active materials of Examples 1 to 3 and Comparative Examples 1 to 4, lithium secondary batteries were fabricated and charged to 4.4 V under CC/CV, 0.1 C conditions, and discharged to 2.5 V under CC, 0.1 C conditions using an electrochemical charge/discharge device at 25° C. The capacities thus obtained were measured and are shown in Table 2 below.

### (2) Low-Temperature Resistance Measurement

The lithium secondary batteries fabricated using the positive-electrode active materials of Examples 1 to 3 and Comparative Examples 1 to 4 were charged to 4.4 V at 0.1 C constant current and discharged to 2.5 V at 0.1 C constant current at 25° C., and this charge/discharge cycle was repeated twice.

Subsequently, the batteries were charged to a state of charge (SOC) of 20% at 25° C. under a 0.1 C rate, and then discharged for 18 seconds at a 2 C rate under −10° C. conditions to measure the voltage variation (ΔV). The resistance was calculated by dividing the measured voltage variation by the current (I) (R=ΔV/I), and the results are shown in Table 2 below.

TABLE 2

| | Capacity (mAh/g) | Resistance (Ω) |
|---|---|---|
| Example 1 | 197.4 | 98 |
| Example 2 | 197.3 | 104.3 |
| Example 3 | 197 | 104.7 |
| Comparative Example 1 | 196.2 | 144.5 |
| Comparative Example 2 | 196 | 113.1 |
| Comparative Example 3 | 196.2 | 109.6 |
| Comparative Example 4 | 196.7 | 119.4 |

Referring to Table 2, it may be confirmed that the lithium secondary batteries of Examples 1 to 3, in which the value of F was within the range of 0.078 to 0.082, exhibited superior capacity and resistance compared with Comparative Example 1, in which the second lithium raw material was not added and the value of F did not fall within the above range. For example, it may be confirmed that the resistance characteristics were significantly improved.

In addition, it may be confirmed that the lithium secondary batteries of Examples 1 to 3, which applied the positive-electrode active materials of the present disclosure having the coating layer heat-treated at temperatures between 735° C. and 790° C., showed improved capacity and resistance characteristics compared with the lithium secondary batteries of Comparative Examples 2 to 4, in which the coating layer was heat-treated at temperatures outside the above range. This is believed to be because the cobalt coating layers of the lithium secondary batteries of Examples 1 to 3 were formed in a more optimized form than those of Comparative Examples 2 to 4.

### Experimental Example 3: Evaluation of High-Temperature Stability

The heat flow of the lithium secondary batteries prepared in Example 1, Comparative Example 1, and Comparative Example 5 was measured according to temperature using a differential scanning calorimeter (DSC) (model name: DSC3, manufactured by METTLER TOLEDO). In this case, the lithium secondary battery using the positive electrode of Comparative Example 5 was fabricated in the same manner as described in Experimental Example 2.

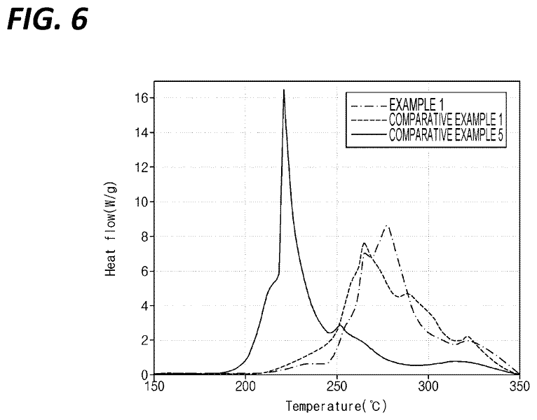

For example, the lithium secondary batteries prepared in Example 1, Comparative Example 1, and Comparative Example 5 were charged to 4.4 V at a constant current of 0.1 C at 25° C., and then disassembled to separate the positive electrodes. The separated positive electrodes were washed with dimethyl acetate, immersed in 20 μL of an electrolyte (1 M LiPF₆, EC:DMC:EMC=3:4:3 by volume), and a DSC analysis was performed on the positive-electrode active materials. For the DSC analysis, the temperature range was set from 100° C. to 400° C., and the heating rate was set to 10° C./min. Each positive electrode was measured by DSC three or more times, and the average values were calculated. The measurement results are shown in Table 3 and FIG. 6 below.

TABLE 3

| | Main exothermic peak temperature (° C.) by |
|---|---|
| | DSC |
| Example 1 | 276.0 |
| Comparative Example 1 | 264.4 |
| Comparative Example 5 | 221.0 |

Referring to Table 3, it may be confirmed that the positive-electrode active material of Example 1 exhibited a higher main peak temperature than both the positive-electrode active material of Comparative Example 1, which was prepared without adding the second lithium raw material, and the positive-electrode active material of Comparative Example 5, which had a higher nickel content. From this, it may be confirmed that the positive-electrode active material of Example 1, prepared by the method for producing a positive-electrode active material according to the present disclosure, exhibited superior thermal stability compared with the positive-electrode active materials of Comparative Examples 1 and 5, which were prepared without applying the method of the present disclosure.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith. Therefore, the technical scope of the various embodiments of the present disclosure is not limited to the detailed descriptions of the invention herein, but should be determined by the scope defined in the claims.

What is claimed is:

1. A positive electrode active material comprising:
lithium nickel-based oxide particles in which a molar ratio of nickel among total transition metals ranges from about 50 mol % to 70 mol %; and
a coating layer formed on a surface of the lithium nickel-based oxide particles and including cobalt,
wherein the lithium nickel-based oxide particles are in a single particle form having one nodule or in a quasi-single particle form that is a composite of 30 or fewer nodules, and
the positive electrode active material satisfies Equation 1:
$$0.078 \leq F \leq 0.082 \qquad [ Equation 1 ]$$
wherein F is a full width at half maximum (FWHM) of a (104) peak measured by X-ray diffraction (XRD) analysis of the positive electrode active material.

2. The positive electrode active material according to claim 1, wherein a molar ratio of nickel in the lithium nickel-based oxide particles ranges from about 60 mol % to 70 mol % based on total transition metals.

3. The positive electrode active material according to claim 1, wherein the lithium nickel-based oxide particles are represented by Formula 1: 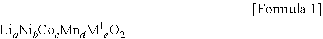
wherein M¹ is at least one selected from Al, Ba, Zr, Ti, Ta, Nb, Y, W, Sr, B, Mg, Mo, Ce, F, and P, and
“a,” “b,” “c,” “d,” and “e” satisfy 0.9≤a≤1.1, 0.5≤b≤0.7, 0<c≤0.5, 0<d≤0.4, and 0≤e≤0.2.

4. The positive electrode active material according to claim 1, wherein a cobalt content included in the coating layer ranges from about 1 mol % to 5 mol % based on 100 mol of the lithium nickel-based oxide.

5. A method of preparing a positive electrode active material, the method comprising:
mixing a transition metal precursor including nickel, cobalt, and manganese with a first lithium raw material, followed by calcination to prepare a lithium nickel-based oxide; and
mixing the prepared lithium nickel-based oxide with a cobalt raw material and a second lithium raw material, followed by heat treatment to prepare a positive electrode active material including a coating layer on a surface of the lithium nickel-based oxide,
wherein the lithium nickel-based oxide is in a single particle form having one nodule or in a quasi-single particle form that is a composite of 30 or fewer nodules.

6. The method of preparing a positive electrode active material according to claim 5, wherein the second lithium raw material is mixed in an amount ranging from about 0.2 parts by weight to 0.8 parts by weight based on 100 parts by weight of the prepared lithium nickel-based oxide.

7. The method of preparing a positive electrode active material according to claim 5, wherein the positive electrode active material satisfies Equation 1:
$$0.078 \leq F \leq 0.082 \qquad [ Equation 1 ]$$
wherein F is a full width at half maximum (FWHM) of a (104) peak measured by X-ray diffraction (XRD) analysis of the positive electrode active material.

8. The method of preparing a positive electrode active material according to claim 5, wherein the heat treatment is performed at a temperature ranging from about 735° C. to 790° C.

9. A positive electrode comprising: the positive electrode active material according to claim 1.

10. A lithium secondary battery comprising:
the positive electrode according to claim 9;
a negative electrode disposed to face the positive electrode;
a separator interposed between the positive electrode and the negative electrode; and
an electrolyte.
